(19) United States
(12) Patent Application Publication
(10) Pub. No.: US 2003/0102219 A1
(43) Pub. Date: Jun. 5, 2003

(54) Reservoir member for electrophoretic member and electrophoretic member

(75) Inventors: Rintaro Yamamoto, Kyoto-shi (JP); Shin Nakamura, Moriyama-shi (JP); Toru Kaji, Kyoto-shi (JP); Takahiro Nishimoto, Soraku-gun (JP)

Correspondence Address: KANESAKA AND TAKEUCHI, Suite 2, 1423 Powhatan Street, Alexandria, VA, 22314, US

(73) Assignee: Shimadzu Corporation

(21) Appl. No.: 10/300,623

(22) Filed: Nov. 21, 2002

(30) Foreign Application Priority Data
Nov. 30, 2001 (JP) 2001-367313

(51) Int. Cl. G01N 27/453

(52) U.S. Cl. 204/600; 204/601

(57) ABSTRACT

A reservoir member is made of an elastic resin material. Additional reservoirs formed of through-holes are provided to the reservoir member at positions corresponding to reservoirs of an electrophoretic member. The surface of the reservoir member to be tightly attached to the electrophoretic member is formed flat. The reservoir member is tightly attached to the electrophoretic member without using any adhesive in such a way that the reservoirs align with the additional reservoirs. Thus, the capacities of the respective reservoirs can be increased. Since the electrophoretic member can be easily separated from the reservoir member, the reservoirs and additional reservoirs can be cleaned easily after the analysis, thereby reducing cross-contamination in samples.

### BACKGROUND AND THE INVENTION AND RELATED ART STATEMENT

This invention relates to a reservoir member for an electrophoretic member (hereinafter referred to simply as “reservoir member”) for increasing a reservoir capacity of the electrophoretic member, and also relates to the electrophoretic member using the same. The electrophoretic member has a plurality of channels formed in a plate-shape member and a plurality of holes as reservoirs formed on one surface of the plate-shape member at positions corresponding to the channels so as to reach the channels.

The reservoir member and the electrophoretic member as described above are used for an electrophoresis for analyzing a small quantity of sample, for example, protein, nucleic acid, medical substance or the like, at a high speed with a high resolution.

When a small quantity of protein, nucleic acid or the like is analyzed, an electrophoresis device has been used. A representative example thereof includes a capillary electrophoresis device. In the capillary electrophoretic device, a migration medium is filled in a glass capillary (hereinafter simply referred to as “capillary”) having an inner diameter less than 100 μm. A sample is introduced into one end of the capillary. Then, both ends of the capillary are connected to buffer liquid so that a high voltage is applied between both ends through the buffer liquid, and the sample to be analyzed is migrated in the capillary. Since the capillary has a large surface area relative to its capacity, i.e. a high cooling effect, a high voltage can be applied thereto, so that the small quantity of the sample, such as deoxyribonucleic acid (hereinafter referred to as “DNA”), can be analyzed at a high speed with a high resolution.

Since the capillary has an outer diameter of 100-500 μm and is very fragile, it is not easy to handle when an operator replaces the capillary. Also, there is often such a case that the thermal radiation is not sufficient, which adversely influences separation conditions. Further, since the voltage is applied to both ends of the capillary through the buffer liquid, it is required for the capillary to have at least a length long enough to be connected to the buffer liquid. Thus, the capillary needs to be designed longer than a specific length.

Therefore, instead of the capillary method, as a device where a analysis speed is high and the device can be made small, there has been proposed an electrophoretic member formed of jointed two base members (hereinafter referred to as “electrophoretic chip”), as shown in D. J. Harrison et al., Anal. Chem. 1993, 283, 361-366. An example of the electrophoretic chip is shown in FIG. 4.

An electrophoretic chip 31 is formed of a pair of transparent plate-shape base members 31a, 31b made of an inorganic material, such as glass, quartz and silicon, or plastics. Migration capillary channels 33, 35, which cross each other, are formed on a surface of one of the base members 31b. Through-holes, i.e. anode reservoir 37a, cathode reservoir 37c, sample reservoir 37s and sample waste reservoir 37w, are provided on a surface of the other of the base members 31a, by a lithography technique or micro-machining technique, which is used in a semiconductor manufacturing process. The electrophoretic chip 31 is used in a state where both base members 31a, 31b are laminated and joined together, as shown in FIG. 4(C). Since the electrophoretic chip as described above is formed of two crossed channels, it is also called as a cross channel type electrophoretic chip.

When the electrophoresis is carried out using the electrophoretic chip 31, prior to the analysis, a migration medium is filled in any of the reservoirs, for example, from the anode reservoir 37a to the channels 33, 35 and in the reservoirs 37a, 37c, 37s, 37w, by, for example, a syringe under pressure. Next, the migration medium filled in the reservoirs 37a, 37c, 37s, and 37w is removed. Then, a sample is injected into the sample reservoir 37s corresponding to one end of a shorter channel (a channel for injecting the sample) 33, and buffer liquid is injected into the other reservoirs 37a, 37c, and 37w.

The electrophoretic chip 31 filled with the migration medium, sample and buffer liquid is mounted on the electrophoresis device. A predetermined voltage is applied to the respective reservoirs 37a, 37c, 37s, and 37w to allow the sample to migrate in the channel 33 to lead to an intersection 39 of both channels 33, 35. The voltage applied to the respective reservoirs 37a, 37c, 37s, and 37w is switched over to another voltage to be applied between the reservoirs 37a, 37c at both ends of the longer channel (separation channel) 35, so that the sample present at the intersection 39 is guided into the channel 35.

After the sample moves into the channel 35, the sample filled in the reservoir 37s is replaced with the buffer liquid. Thereafter, the voltage for the electrophoresis is applied to the respective reservoirs 37a, 37c, 37s, and 37w, so that the sample moved in the channel 35 is separated in the channel 35. A detector disposed at a suitable position in the channel 35 detects the sample separated by the electrophoresis. The detection is carried out by an absorptiometric method, fluorophotometric method, electrochemical method or conductometric method.

Also, a structure of the channel of the electrophoretic chip and an analyzing condition, such as a composition of the migration medium, depend on its purpose or the sample. As another channel structure, for example, shown in Yining Shi et al., Anal. Chem. 1999, 71, 5354-5361, there is an electrophoretic member having a plurality of separating channels formed in a radial shape.

Recently, there have been used an electrophoretic member larger than the electrophoretic chip, an electrophoretic member having a plurality of channels, and an electrophoretic member having straight channels without the intersection of the channels. The electrophoretic member according to the present invention includes all of them.

The electrophoretic chip can be applied to various purposes. Among them, there is an application requiring a relatively long migration time, such as DNA sequence wherein a high resolution is necessary so that the channels have to be designed longer. In such an application, the buffer liquid in the reservoirs is reduced through evaporation while migrating. When a total amount of the buffer is small relative to the reduced quantity of the buffer, a buffer concentration is changed greatly, thereby changing pH and an ion concentration of the buffer. Therefore, the migration can not be carried out under the original conditions to thereby preventing stable analysis.

To solve such a problem, a cylindrical wall made of a resin is attached around the reservoir by an adhesive to create an additional capacity in the interior of the cylindrical resin wall for increasing the reservoir capacity. According to the method, since the total amount of the buffer in the reservoir can be increased relative to the reduced quantity of the buffer due to the evaporation, above-mentioned problems, such as change in the buffer concentration, can be prevented.

Incidentally, it is essential that the electrophoretic chip used for the analysis be washed and cleaned to prevent cross-contamination in the samples.

However, in the electrophoretic chip provided with the cylindrical resin wall to increase the reservoir capacity, it takes a long time to wash and clean the interior thereof to completely prevent the cross-contamination in the samples since the reservoir is difficult to wash efficiently.

Further, the sample reservoir requires special attention to clean the interior thereof. In the electrophoretic chip having three different reservoirs, such as the cathode reservoir, sample reservoir and sample waste reservoir, in a closely attached state, especially, in the multi-channel electrophoretic chip including a plurality of channels, a risk of the cross-contamination among the samples is increased, since the plural reservoirs are closely formed.

In view of the above defects, the present invention has been made and an object of the invention is to provide a reservoir member for an electrophoretic member and the electrophoretic member wherein the reservoir capacity can be increased and the cross-contamination in the samples can be greatly reduced.

Further objects and advantages of the invention will be apparent from the following description of the invention.

### SUMMARY OF THE INVENTION

A reservoir member for an electrophoretic member (hereinafter referred to simply as a “reservoir member”) according to the present invention is mounted on a surface of the electrophoretic member where a plurality of channels is formed in a plate-shape member and a plurality of holes connected to the channels is formed as reservoirs at positions corresponding to the channels on the surface of the plate-shape member. The reservoir member is made of an elastic resin material. A surface of the reservoir member to be tightly attached to the surface of the electrophoretic member is formed flat, and the reservoir member includes through-holes as additional reservoirs so that the through-holes communicate with the reservoirs in a state where the reservoir member is tightly attached to the reservoirs.

The electrophoretic member according to the invention is structured such that a plurality of channels is formed in the plate-shape member, and a plurality of holes as the reservoirs, which reach the channels, is formed at positions corresponding to the channels on one surface of the plate-shape member. The electrophoretic member is provided with the reservoir member on the one surface thereof, and the reservoir member is detachable and made of an elastic resin material. A surface to be tightly attached to the one surface of the electrophoretic member is formed flat and a plurality of through-holes is formed as additional reservoirs communicating with the reservoirs in a state that the reservoir member is tightly attached on the reservoirs.

The reservoir member is formed of an elastic resin material and has a flat surface to be attached to the electrophoretic member. Therefore, the reservoir member can be detachably mounted on the electrophoretic member without using any adhesive, and the reservoir capacity can be increased. Further, since the reservoir member is tightly attached to the electrophoretic member without using any adhesive, the electrophoretic member and the reservoir member therefor can be separated and cleaned after the use. Thus, the electrophoretic member and the reservoir member can be easily washed and cleaned, thereby reducing cross-contamination in samples. The reservoir member may be disposable.

It is preferable that the reservoir member of the invention is a molded product formed by injecting a resin material into a mold in which members for defining the positions of the above-stated through-holes are arranged. Thus, it is possible to change a thickness of the reservoir member, that is, an additional reservoir capacity, as desired by changing a quantity of the resin material injected into the mold.

### BRIEF DESCRIPTION OF THE DRAWINGS

FIG. 1 is a perspective view of an embodiment of a reservoir member for an electrophoretic chip (hereinafter referred to simply as “reservoir member”) and the electrophoretic chip according to the invention, wherein the reservoir member and the electrophoretic chip are separated;

FIG. 2 is a perspective view of the embodiment, wherein the reservoir member is tightly attached to the electrophoretic chip;

FIG. 3 is a perspective view showing an example of a mold for molding a PDMS reservoir member together with a PDMS reservoir member; and

FIGS. 4(A), 4(B), 4(C) show an example of a conventional electrophoretic chip, wherein FIG. 4(A) is a top plan view showing an upper surface of one of base members; FIG. 4(B) is a top plan view showing an upper surface of the other of the base members; and FIG. 4(C) is a side view showing a state where both members are laminated each other.

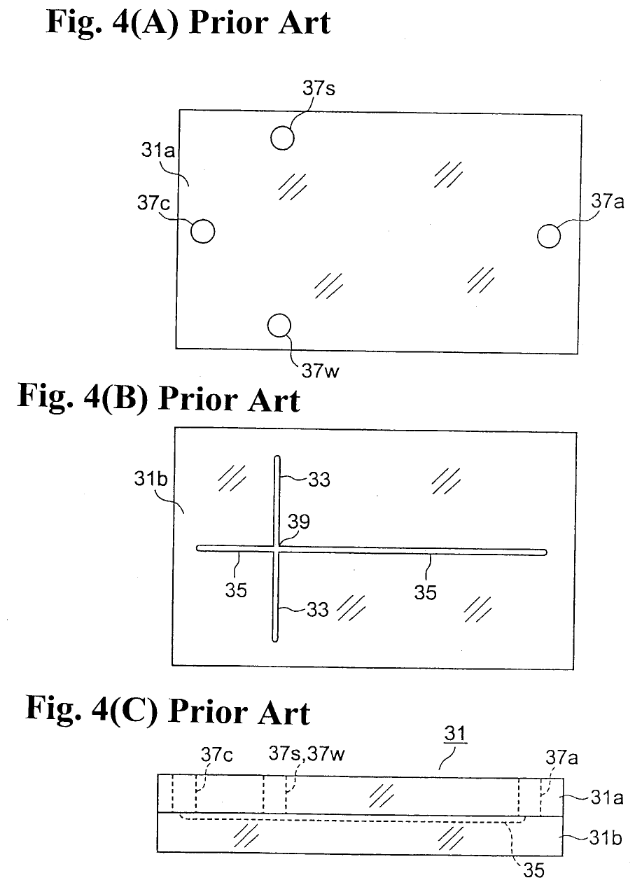

### DETAILED DESCRIPTION OF THE PREFERRED EMBODIMENT

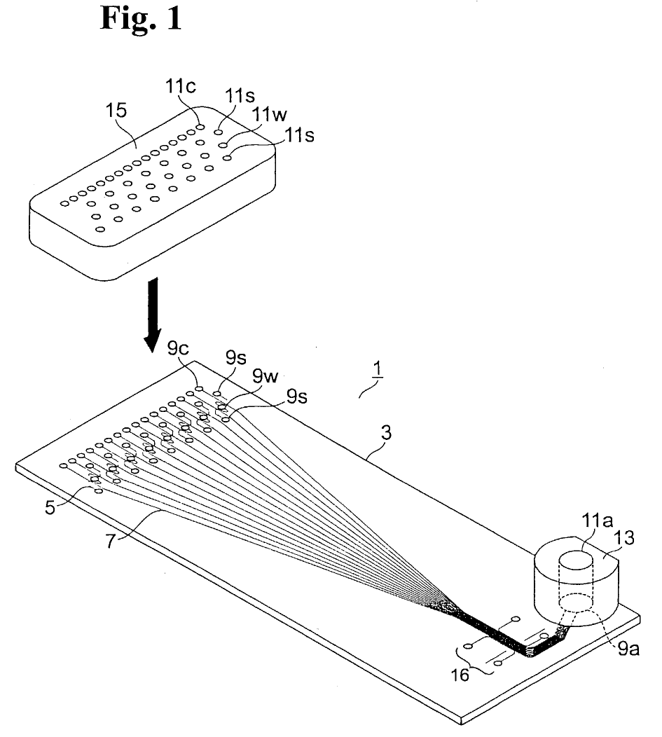

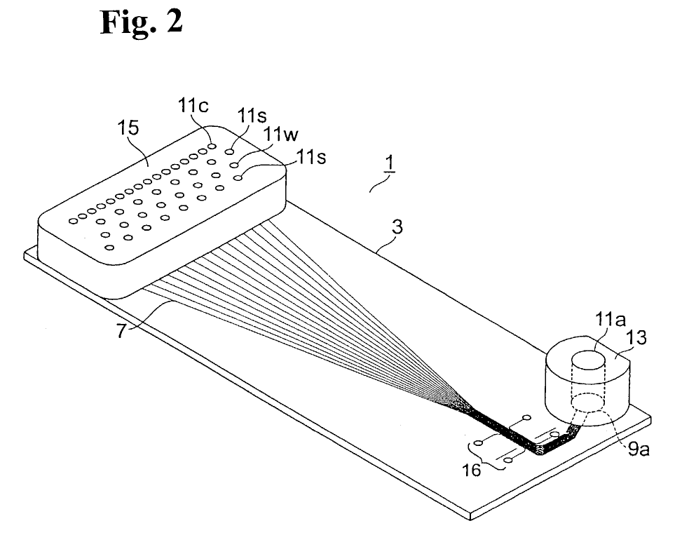

FIG. 1 is a perspective view showing an embodiment of a reservoir member and an electrophoretic chip according to the invention in a state that the reservoir member and an electrophoretic chip are separated. FIG. 2 is a perspective view showing the same embodiment, wherein the reservoir member is tightly attached to the electrophoretic chip.

An electrophoretic chip 1 is formed of a pair of base plates 3 formed of transparent plates made of an inorganic material, such as glass, quartz and silicon, or a plastic.

On a surface of one of the pair of the plates constituting the base plate 3, sixteen sets of a sample injection channel 5 and a separation channel 7, which cross each other, are formed by a semiconductor lithography technique or a micro-machining technique. The sixteen sets of the channels 5, 7 are disposed in a fan shape with one end of the separation channels 7, as a pivot, located on a side where each separation channel 7 does not cross each sample injection channel 5 so that the channel 5 or channel 7 of one set dose not cross the channel 5 or channel 7 of the other set.

On one of the base plates constituting the base plate 3 on which the channels 5, 7 are formed or on the other thereof, a plurality of through-holes as an anode reservoir 9a, cathode reservoirs 9c, sample reservoirs 9s and sample waste reservoirs 9w is formed at positions corresponding to ends of the channels 5, 7. The cathode reservoir 9c and the sample reservoir 9s are provided to every set of the channels 5, 7. The sample waste reservoir 9w is provided to every adjacent two sets of the channels 5, 7. The anode reservoir 9a is located on one end side of the respective separation channels 7, i.e. the pivot side of the separation channels 7 disposed in the fan shape, and is commonly used.

Further, on the surface of the base plate where the reservoirs 9a, 9c, 9s and 9w are provided, an anode side reservoir member 13 is bonded by an epoxy-type adhesive at a position corresponding to the anode reservoir 9a. The anode side reservoir member 13 is made of, for example, an acrylic resin and is provided with a through-hole as an additional anode reservoir 11a communicating with the anode reservoir 9a.

The electrophoretic chip 1, as shown in the drawing, is used in a state that the one base plate and the other base plate constituting the base plate 3 are laminated with each other and joined together. A detection area 16 for detecting a separated sample in the electrophoretic chip 1 is located in the vicinity of the anode reservoir 9a. Reserved channels are provided on both sides of an array of the separation channels 7 in the detection area 16, respectively. When a focal point of a detection optical system is set in the separation channel 7, a fluorescence dye, such as fluorescein isothiocyanate (hereinafter referred to as “FITC”), is injected into the reserved channels to adjust the focal point. Also, the reserved channels can be used to confirm the joint between the two base plates constituting the base plate 3 by checking an electric leak between the both reserved channels sandwiching the array of the separation channels 7.

The electrophoretic chip structured as described above can be also called as a multi-channel microchip since a number of separation channels are formed.

Further, a reservoir member 15 (a reservoir member for the electrophoretic member) is provided on the surface of the base plate on which the reservoirs 9a, 9c, 9s and 9w are provided. The reservoir member is made of an elastic resin material such as polydimethylsiloxane (hereinafter referred to as “PDMS”). On the PDMS reservoir member 15, there are provided a plurality of through-holes as additional cathode reservoirs 11c formed at positions corresponding to the cathode reservoirs 9c; a plurality of through-holes as additional sample reservoirs 11s formed at positions corresponding to the sample reservoirs 9s; and a plurality of through-holes as additional sample waste reservoirs 11w formed at positions corresponding to the sample waste reservoirs 9w. The surface of the PDMS reservoir member 15 to be tightly attached to the electrophoretic chip 1 is formed flat.

In a state where the electrophoretic chip 1 is used, as shown in FIG. 2, the PDMS reservoir member 15 is tightly fixed to the electrophoretic chip 1 so that the cathode reservoirs 9c communicate with the additional cathode reservoirs 11c; the sample reservoirs 9s communicate with the additional sample reservoirs 11s; and the sample waste reservoirs 9w communicate with the additional sample waste reservoirs 11w.

When the PDMS reservoir member 15 is attached to the electrophoretic chip 1, since the PDMS reservoir member 15 has the elasticity and the flat surface to be tightly attached to the electrophoretic chip 1, the PDMS reservoir member 15 can be tightly attached to the electrophoretic chip 1 without using any adhesive by pressing the PDMS reservoir member 15 against the electrophoretic chip 1 to remove the air held between the contacting surfaces. Accordingly, the reservoir capacities of the cathode reservoir, sample reservoir and sample waste reservoir can be increased.

When the electrophoresis is carried out using the electrophoretic chip 1, before the analysis is carried out, a migration medium is filled in the separation channel 7 and sample injection channel 5 through the anode reservoir 9a from the additional anode reservoir 11a through, for example, pressurized transfer by a syringe. Further, the migration medium is filled in the reservoirs 9c, 9s, and 9w and additional reservoirs 11c, 11s, and 11w through the channels 5, 7. Then, the migration medium filled in the reservoirs 9a, 9c, 9s, and 9w and additional reservoirs 11a, 11c, 11s, and 11w is removed. The sample is injected into the sample reservoirs 9s, and buffer liquid is injected into the reservoirs 9a, 9c, and 9w and additional reservoirs 11a, 11c, and 11w.

Since the PDMS reservoir member 15 is tightly mounted on the electrophoretic chip 1 without using any adhesive, the PDMS reservoir member 15 can be easily removed from the electrophoretic chip 1 after the analysis.

The interiors of the cathode reservoir 9c, sample reservoir 9s and sample waste reservoir 9w of the electrophoretic chip 1 can be directly and easily cleaned after removing the PDMS reservoir member 15. The anode side reservoir member 13 is fixed on the anode reservoir 9a by an adhesive. Since there is little risk of contamination among the samples in the anode reservoir 9a, the electrophoretic chip 1 can be washed and cleaned in a state where the anode side reservoir member 13 is attached thereto.

The PDMS reservoir member 15 removed from the electrophoretic chip 1 can be easily cleaned by running water or ultrasonic, so that the contamination in the samples is negligible. Also, since the PDMS reservoir member 15 can be produced at a low cost, the PDMS reservoir member 15 may be disposable.

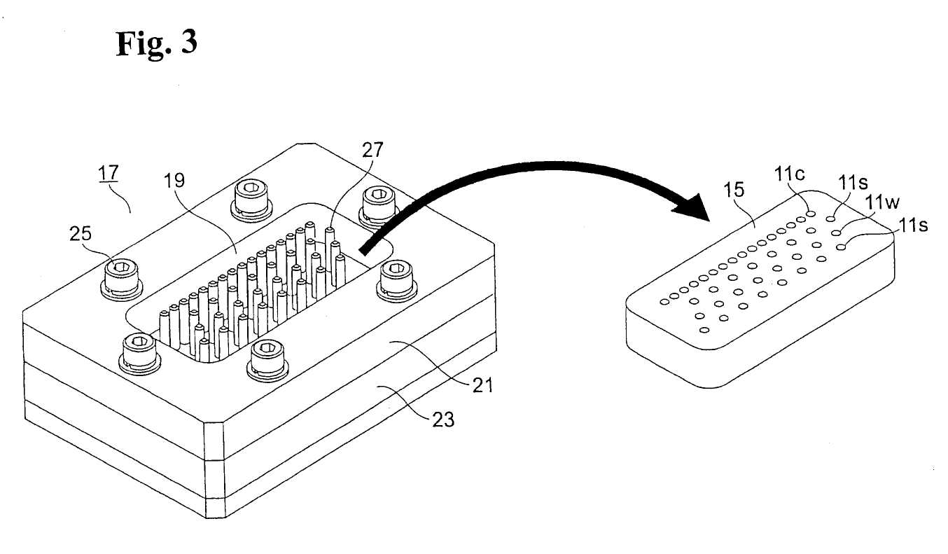

FIG. 3 is a perspective view showing an example of a mold for molding the PDMS reservoir member together with the PDMS reservoir member.

A mold 17 includes a receptacle 19 for defining an external shape of the PDMS reservoir member 15. The receptacle 19 is formed of a member 21 provided with an opening portion for forming side surface portions of the receptacle 19, and a member 23 for forming a bottom portion of the receptacle 19. The members 21, 23 are detachable and tightly fixed by screws 25.

A plurality of pins 27 is arranged in the receptacle 19 at positions corresponding to the additional cathode reservoirs 11c, additional sample reservoirs 11s and additional sample waste reservoirs 11w. The pins 27 are detachably fixed to a surface of the member 23 constituting the bottom portion of the receptacle 19.

An example of a production method of the PDMS reservoir member will be explained with reference to FIG. 3.

(1) A main component PDMS Sylbot 148 (a product of Dow Corning U.S.A.) and a curing agent are mixed at a ratio of 10:1 by weight to obtain a PDMS mixture.

(2) The PDMS mixture is placed in a bell jar (a container for forming a vacuum space), and an interior pressure of the bell jar is reduced to remove air from the mixture for 30 minutes by using, for example, a vacuum pump or diaphragm pump.

(3) The mold 17 is assembled, and a mold release is applied to the surfaces of the receptacle 19 and pins 27. As the mold release, for example, a silicon mold release for the general purpose can be used, and is sprayed for about 5 seconds. Also, a two to five percent aqueous solution of a household neutral detergent can be used as the mold release.

(4) The air-free PDMS mixture is slowly injected into the receptacle 19 of the mold 17 in such a way that bubbles do not form. A thickness of the PDMS reservoir member 15, i.e. the capacities of the additional cathode reservoirs 11c, additional sample reservoirs 11s and additional sample waste reservoirs 11w, can be controlled by adjusting the injected quantity of the PDMS mixture.

(5) The mold 17 is placed in a thermostatic tank at a temperature of, for example, 65° C. for 4 hours. In that case, if it takes too long a time for the curing, the PDMS reservoir member 15 becomes too hard to attach the PDMS reservoir member 15 to the electrophoretic chip 1.

(6) After a predetermined time has passed, the mold 17 is taken out from the thermostatic tank and cooled down naturally. Thereafter, the mold 17 is pulled down to take out the PDMS reservoir member 15 therefrom.

When the PDMS reservoir member 15 is mounted to the electrophoretic chip 1, after the surface of the electrophoretic chip 1 is cleaned, the cathode reservoirs 9c are aligned with the corresponding additional cathode reservoirs 11c to communicate with each other. Likewise, the sample reservoirs 9s are aligned with the corresponding additional sample reservoirs 11s to communicate with each other, and the sample waste reservoirs 9w are aligned with the corresponding additional sample waste reservoirs 11w to communicate with each other. Then, the PDMS reservoir member 15 is tightly attached to the electrophoretic chip 1. Thus, the capacities of the cathode reservoirs, sample reservoirs and sample waste reservoirs are increased.

In the present embodiment, PDMS is used as a resin material of the PDMS reservoir member. However, the present invention is not limited thereto, and it is possible to use any resin material that can be detachably and tightly attached to the surface of the electrophoretic chip.

Also, the reservoir member and the electrophoretic member according to the present invention are not limited to the PDMS reservoir member 15 and the electrophoretic chip 1, as shown in FIG. 1. It is also possible to use any plate-shape member, as long as the plate shape member has the channels formed in the interior thereof, the holes provided at the positions corresponding to the channels formed on one surface of the plate-shape member for providing the reservoirs, and a surface area to which the reservoir member can be tightly attached.

Also, the reservoir member is not limited to the molded product, and it may be produced by the other method.

The reservoir member according to the present invention is made of an elastic resin material. The surface of the reservoir member is formed flat and tightly attached to the electrophoretic member. The reservoir member includes the through-holes as additional reservoirs communicating with the reservoirs in a state where the reservoir member is tightly attached on the reservoirs. The electrophoretic member of the invention includes the reservoir member detachably provided thereto. Thus, the reservoir member can be detachably attached to the electrophoretic member without using any adhesive, which results in the increased reserving capacities. Further, since the electrophoretic member and the reservoir member therefor can be separated after the use, the electrophoretic member and the reservoir member can be easily cleaned, and the cross-contamination in the samples can be reduced. Also, the reservoir member may be disposable.

While the invention has been explained with reference to the specific embodiments of the invention, the explanation is illustrative and the invention is limited only by the appended claims.

What is claimed is:

1. A reservoir member for an electrophoretic member that has a plate-shape member, at least one channel formed in the plate-shape member, and at least one hole formed in the electrophoretic member at one side thereof at a position corresponding to the at least one channel in the plate-shape member for communicating therewith, comprising:
a main body made of a resin material and having a flat surface to be tightly attached to the one side of the electrophoretic member, and
at least one through-hole formed in the main body and communicating with the at least one hole of the electrophoretic member in a condition that the main body is fixed to the electrophoretic member.

2. A reservoir member for an electrophoretic member according to claim 1, wherein said reservoir member is a molded product having the at least one through-hole therein.

3. A reservoir member for an electrophoretic member according to claim 1, wherein said resin material is an elastic material.

4. An electrophoretic member, comprising:
a plate-shape member,
at least one channel formed in the plate-shape member,
at least one hole formed in the plate-shape member at one side thereof at a position corresponding to the at least one channel for communicating therewith, and
a reservoir member having a main body made of an elastic resin material, said main body having a flat surface to be tightly attached to the one side of the electrophoretic member, said reservoir member including at least one through-hole communicating with the at least one hole of the electrophoretic member in a condition that the main body is fixed to the electrophoretic member.
